(19) United States
(12) Patent Application Publication
(10) Pub. No.: US 2009/0006717 A1
(43) Pub. Date: Jan. 1, 2009

(54) EMULATION OF READ-ONCE MEMORIES IN VIRTUALIZED SYSTEMS

(76) Inventors: Michael Rothman, Puyallup, WA (US); Vincent J. Zimmer, Federal Way, WA (US)

Correspondence Address: SCHWEGMAN, LUNDBERG & WOESSNER, P.A., P.O. BOX 2938, MINNEAPOLIS, MN, 55402, US

(21) Appl. No.: 11/771,732

(22) Filed: Jun. 29, 2007

(51) Int. Cl. G06F 12/00

(52) U.S. Cl. 711/102; 711/E12.001

(57) ABSTRACT

The subject matter herein relates to computer systems and, more particularly, to emulation of read-once memories in virtualized systems. Various embodiments described herein provide systems, methods, and software that leverage the value of read-once memory for purposes such as keeping data or instructions secret and protected from unauthorized viewers, applications, hackers, and other processes. Some such embodiments include a virtual machine manager that emulates hardware memories in a system memory to facilitate virtual access to the hardware memories.

### TECHNICAL FIELD

The subject matter herein relates to computer systems and, more particularly, to emulation of read-once memories in virtualized systems.

### BACKGROUND INFORMATION

A flash memory is a popular form of nonvolatile memory that can be

erased aid reprogrammed in units of memory called blocks. A common use for flash memory is to store the BIOS for a computing system. The BIOS is the essential system code or instructions used to control system configuration and to load the operating system for the computing system. In particular, BIOS provides the first instructions that a computing system executes when it is first turned on. Because the BIOS is critical to the computing system, protection of the integrity of the BIOS is essential. Hence, a computing system should protect the security and integrity of the BIOS in flash memory. It may also be desirable, to restrict access by operating systems or application programs to other areas of the flash memory once the computing system has been initialized.

Some flash memories in computing systems now have blocks of memory that may be read only once per machine reset. One example is a compressed BIOS that is decompressed into a larger system memory which is protected from corruption through the use of locking bits that are only reset upon system restart. However, these solutions are hardware dependent. Being hardware dependent, these systems are not able to provide the needed security of read once memories when a virtual machine manager is employed. If a virtual machine manager is concurrently operating two virtual machines and one virtual machine needs to be reset, the entire system must be reset, taking both virtual machines offline to make the BIOS stored in read-once memory available again. Further, if both virtual machines need a same portion of the BIOS from a read-once memory to boot, it is generally not possible for both virtual machines operate concurrently.

### BRIEF DESCRIPTION OF THE DRAWINGS

FIG. 1 illustrates an example computing system 100 in which the present subject matter may be implemented.

FIG. 2 is a block flow diagram of a method according to an example embodiment.

FIG. 3 is a block flow diagram of a method according to an example embodiment.

### DETAILED DESCRIPTION

Various embodiments described herein provide systems, methods,

and software that leverage the value of read-once memory for purposes such as keeping data or instructions secret and protected from unauthorized viewers, applications, hackers, and other processes. Some such embodiments include a virtual machine manager that emulates hardware memories in a system memory to facilitate virtual access to the hardware memories. In one such embodiments, a virtual machine manager emulates a block of a system BIOS by mapping the block to a system memory upon request for the block of the BIOS from a requesting virtual machine. After the block is read by the virtual machine, the virtual machine manager un-maps the block and then writes zeros or other data over the same block to obliterate the data. These and other embodiments are described herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the example process flow is applicable to software, firmware, and hardware implementations.

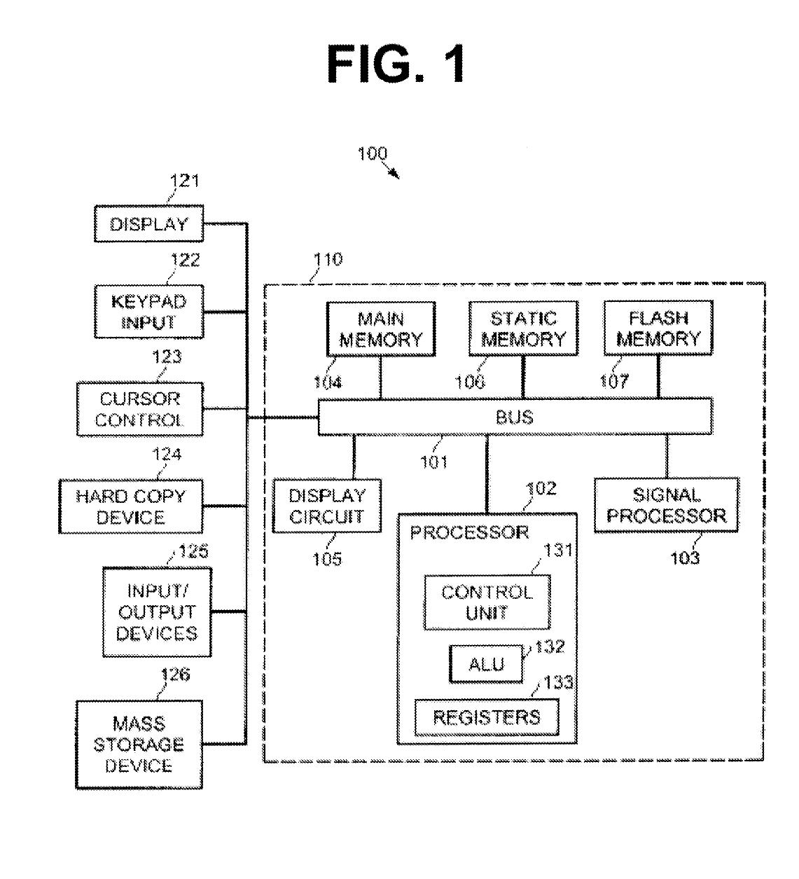

FIG. 1 illustrates an example computing system 100 in which the present subject matter may be implemented. The emulated memory locking techniques described herein for BIOS or other code and/or data may be implemented and utilized within computing system 100, which can represent a general purpose computer system (e.g., a personal computer (PC)), portable computer system, hand-held electronic device, or other computing device. The components of computing system 100 are merely examples and one or more components can be omitted or added. For example, one or more input/output (I/O) devices or memory devices (not shown) can be added to computing device 100.

Referring to FIG. 1, computing system 100 includes resources such as a main unit 110 having a processor 102 and a signal processor 103 coupled to a display circuit 105, main memory 104, static memory 106, and flash memory 107 via bus 101. Signal processor 103 may operate as a co-processor with processor 102. Signal processor 103 may be an optional processing unit within computing system 100. Main unit 110 of computing system 100 may also be coupled to a display 121, keypad input 122, cursor control 123, hard copy device 124, input/output (I/O) devices 125, and mass storage device 126 via bus 101. The display circuit 105, in various embodiments may include an advanced graphics port circuit or other graphics circuit.

Bus 101 comprises a standard system bus for communicating information and signals. Processor 102 and/or signal processor 103 are processing units for computing system 100. Processor 102 or signal processor 103 or both can be used to process information and/or signals for computing system 100. Processor 102 may be used to process code or instructions to perform the emulated memory locking techniques described herein. Alternatively, signal processor 103 may be used to process encoded instructions to perform the emulated memory locking techniques described herein. Processor 102 includes a control unit 135, an arithmetic logic unit (ALU) 132, and several registers 133, which can be used by CPU 102 to process information and/or signals and to perform the emulated memory locking techniques described herein. Signal processor 103 can also include similar components as processor 102.

Main memory 104 may be, e.g., a random access memory (RAM) or some other dynamic storage device, for storing information or instructions (program code), which are used by processor 102 or signal processor 103. For example, main memory 104 may be used to store operating system software. Main memory 104 may also store temporary variables or other intermediate information during execution of instructions by processor 102 or signal processor 103. Static memory 106, may be, e.g., a read only memory (ROM) and/or other static storage devices, for storing information or instructions, which can also be used by processor 102 or signal processor 103.

Flash memory 107 comprises a nonvolatile memory device that can be erased and reprogrammed in units of memory called blocks. In one embodiment, flash memory 107 stores BIOS code or instructions for computing system 100. As will be explained in further detail below in connection with the following embodiments, one or more selected blocks may be protected such that the code and/or data stored in those regions cannot he read or changed after a certain time during system initialization processing. In typical embodiments of the inventive subject matter, some or all of these selected blocks that may be protected from reads or changes may be emulated with the main memory 104 of the computing system 101 by a virtual machine manager to allow more than one virtual machine, such as one or more operating systems, to operate on the computing system 101.

Display 121 may be, e.g., a cathode ray tube (CRT) or liquid crystal display (LCD). Display 121 may display information or graphics to a user. Computing system 101 may interface with display 121 via display circuit 105. Keypad input 122 comprises an alphanumeric input device for communicating information and command selections to computing system 100. Cursor control 123 may be, e.g., a mouse, a trackball, or cursor direction keys, for controlling movement of an object on display 121. Hard copy device 124 may be, e.g., a laser printer, for printing information on paper, film, or some other like device. Input/output (I/O) devices 125 may represent any number of I/O devices that can be coupled computing system 100. For example, a digital camera may be coupled to computing system 100 as an I/O device. Mass storage device 126 may be a storage device such as a read/writable compact disc (CD) or digital video disk (DVD) drive.

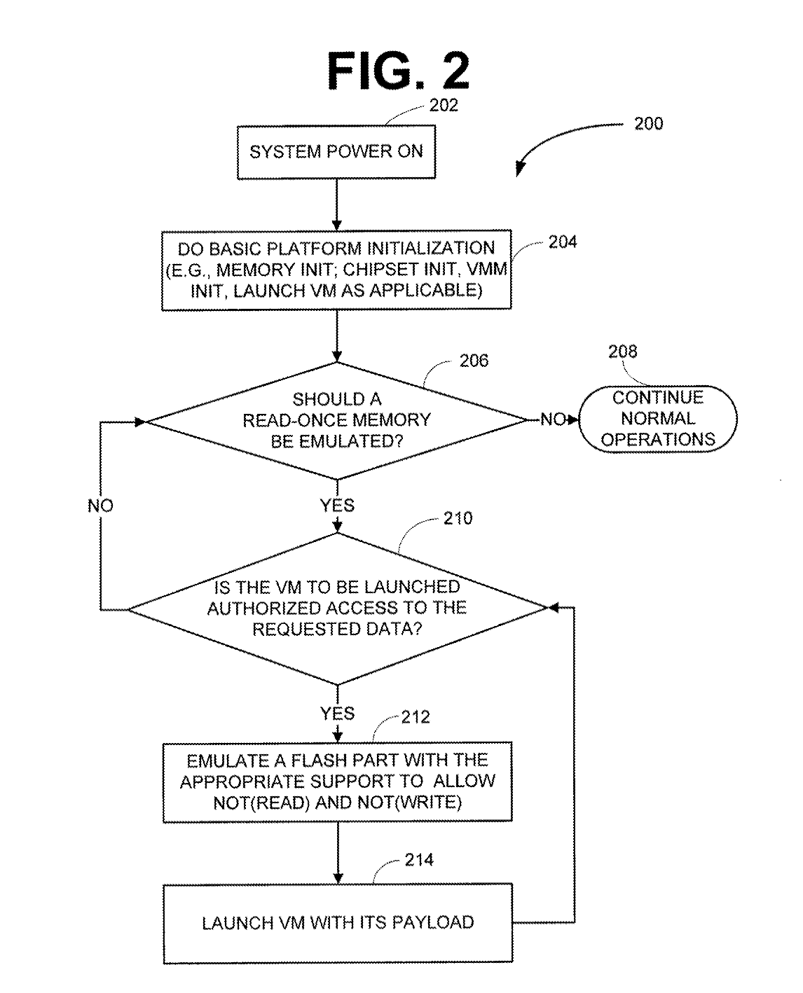

FIG. 2 is a block flow diagram of a method 200 according to an

example embodiment. The method 200 is a method of initializing a computing system, such as the computing system 100 of FIG. 1, when the computing system includes a virtual machine manager and one or more virtual machines. A virtual machine manager may also be referred to as a hypervisor.

The example method 200 includes power the computing system on 202 and performing a platform initialization 204. The platform initialization may include initializing the system resources such as memory, a display circuit, the chipset, etc. The initialization may also include initializing a virtual machine manager and one or more virtual machines.

The method 200, when initializing the system, such as when initializing a virtual machine within a virtual machine manager, determines if a read-once memory should be emulated 206 upon certain memory accesses. This determination 206 may be made by a process of a virtual machine manager or another process. In the event that a memory access request is made by the virtual machine for data or instructions considered by the virtual machine manager to be sensitive, such embodiments typically include emulating the access to data or instructions. In some embodiments, the data or instructions may include instructions for performing cryptographic operations or keys that are used therefore. If a read-once memory is not emulated, normal operations continue 208.

However, if a read-once memory is emulated, a determination is made if the virtual machine to be launched is authorized to access the data requested 210. If not, method 200 returns to determine if a read-once memory should be emulated 206 for a next data request. If tire virtual machine is authorized to access the data, the virtual machine manager 212 emulates a portion of the requested data 212, such as a portion of a flash memory, with the appropriate support in the virtual machine manager to allow protection of the emulated read-once memory. The virtual machine may then continue launching 214.

In some embodiments, upon emulation of a read-once memory, one or more processes, if not already executed within the virtual machine manager, are called or are otherwise made available, to provide support for read-once memory emulation. In some embodiments, this support includes processes that may execute to instantiate an emulated read-once memory data structure. Such data structures may include a block portion to hold a block of data and three bit portions to hold locking bits. The locking bits may include a read lock bit, which when true informs a virtual machine manager to prevent virtual machines from reading the data in the block portion. The locking bits may also include a write lock bit, which when true informs the virtual machine manager to prevent virtual machines from writing data to the block portion. The third locking bit is a lock down bit, which, in some embodiments, may only be set to true when both the read lock and write lock bits are set to true. When the locking bit is true, the data block may not be accessed in any fashion by virtual machine until the virtual machine is reset. This prevent access to the data or instructions in the emulated read-once memory by other processes or end users which may compromise sensitive information or allow the virtual machine to become corrupt.

To reset the emulated read-once memory the entire physical system does not need to be reset. This is so because the virtual machine executes within a virtual computing environment of the virtual machine manager. Performing a “virtual reset” of the virtual machine resets the read-once memory.

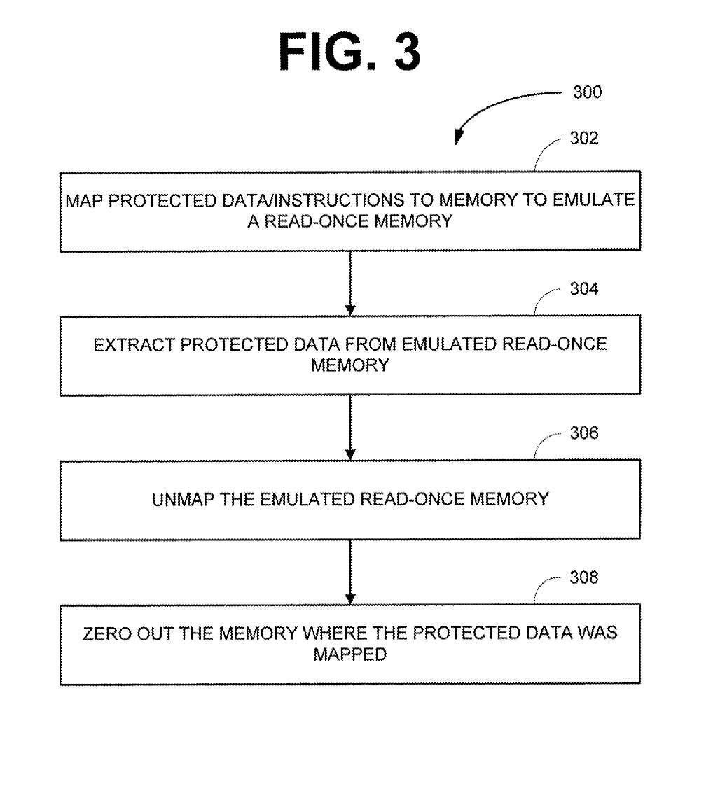

FIG. 3 is a block flow diagram of a method 300 according to an

example embodiment. The example method 300 is a method of emulating a read-once memory. In some embodiments, the method 300 is triggered by a virtual machine process requesting protected data from a virtual machine manager. The example method 300 includes a process, such as the virtual machine manager, mapping protected data or instructions to a memory to emulate a read-once memory 302. In some embodiments, the mapping 302 may include allocating a space in a main memory of a computing system and copying data to the allocated space.

The method 300 further includes the triggering process extracting the protected data from the emulated read-once memory 304. The extracting 304 may include performing cryptographic operations such as decrypting or encrypting data or instructions. The extracting may also include other operations such compressing/decompressing, reading, writing, and other operations. After the data is read, or otherwise manipulated by the triggering process, the emulated read-once memory is unmapped 306. The unmapping may include a deallocation or release of the allocated memory space. Some embodiments also include zeroing out the previously mapped memory space where the protected data was stored 308. The zeroing out 308 may include writing data, which may or may not actually include zeros, into the previously mapped memory space.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
if a virtual machine utilizes a read-once memory capability of a virtual computing device, emulating a read-once memory in a memory of the virtualized computing device for sensitive data the virtual machine is authorized to access;
launching the virtual machine and populating one or more read-once memory portions emulated in the memory of the virtualized computing device;
for each emulated read-once memory portion when first read by a process of the virtual machine:
extracting the data from the emulated read-once memory portion, and
unmapping the emulated read-once memory portion.

2. The method of claim 1, further comprising:
for each emulated read-once memory portion when first read by a process of the virtual machine, after the unmapping of the emulated read-once memory portion, zeroing-out the emulated read-once memory portion in the memory of the virtualized computing device.

3. The method of claim 1, wherein emulating a read-once memory portion in the virtualized computing device includes:
mapping the read-once memory portion in a random access memory (“RAM”) address space of the virtual computing device.

4. The method of claim 1, wherein unmapping the emulated read-once memory portion prevents subsequent access of the emulated read-once memory portion until the virtual machine is reset within the virtualized computing device.

5. The method of claim 4, wherein a reset of the virtual machine does not require a reset of the virtualized computing device.

6. The method of claim 1, wherein the virtual computing device is a personal computer virtualized by a virtual machine manager.

7. The method of claim 1, wherein extracting the data from the emulated read-once memory portion includes at least one of executing instructions and accessing data from the emulated read-once memory portion.

8. The method of claim 7, wherein at least one of executing instructions and accessing data comprises performing cryptographic operations within an operating space of the virtual machine.

9. The method of claim 8, wherein unmapping the emulated read-one memory portion comprises locking the emulated read-one memory portion in the memory of the virtualized computing device based on the executed instructions such that all access to the emulated read-one memory portion is locked to the virtual machine.

10. A computer-readable medium, within instructions thereon, which when executed, cause a suitably configured computing device to perform the method of claim 1.

11. A computing system comprising:
system resources including a system memory;
a processor coupled to the system resources; and
a virtual machine manager instruction set stored in the system memory and executable by the processor to virtualize at least a subset of the system resources utilized by one or more virtual machine instruction sets, the virtual machine manager instructions operable on the processor to:
launch a virtual machine and emulate one or more read-once memories; and
for each emulated read-once memory, when first read by a process of the virtual machine:
extract the data from the emulated read-once memory,
unmap the emulated read-once memory, and
zero-out the emulated read-once memory.

12. The computing system of claim 11, wherein unmapping an emulated read-once memory prevents subsequent access of the emulated read-once memory until the virtual machine is reset within the virtualized machine manager.

13. The computing system of claim 12, wherein a reset of the virtual machine does not require a reset of the computing system or virtual machine manager.

14. The computing system of claim 11, wherein extracting the data from an emulated read-once memory includes at least one of executing instructions and accessing data from the emulated read-once memory.

15. The computing system of claim 11, wherein the system resources further include an advanced graphic port (“AGP”) video circuit.
